(19) United States
(12) Patent Application Publication
(10) Pub. No.: US 2026/0371243 A1
(43) Pub. Date: Nov. 19, 2026

(54) AUTONOMOUS PHYSICAL RANDOM ACCESS CHANNEL POWER CONTROL

(71) Applicant: QUALCOMM Incorporated, San Diego, CA (US)

(72) Inventors: Navid ABEDINI, Basking Ridge, NJ (US); Jianghong LUO, Skillman, NJ (US); Xiaoxia ZHANG, San Diego, CA (US); Tao LUO, San Diego, CA (US)

(21) Appl. No.: 19/667,390

(22) Filed: May 4, 2026

Related U.S. Application Data
(60) Provisional application No. 63/805,897, filed on May 14, 2025.

(51) Int. Cl. H04W 52/02; H04W 74/0833

(52) U.S. Cl. CPC H04W 52/0225; H04W 74/0833

(57) ABSTRACT

This disclosure provides methods, components, devices and systems for wireless communication. For example, a user equipment (UE) may receive a signal that identifies a parameter set associated with power ramping operations during physical random access channel (PRACH) transmissions, where the parameter set includes at least a first subset of power ramping parameters associated with a first PRACH retransmission and a second subset of power ramping parameters associated with a second PRACH retransmission, and where the first subset of power ramping parameters includes one or more parameter values that are different relative to corresponding parameter values of the second subset of power ramping parameters. The UE may perform the first PRACH retransmission according to the first subset of power ramping parameters. The UE may perform the second PRACH retransmission according to the second subset of power ramping parameters.

### CROSS REFERENCE

The present Application for Patent claims priority to U.S. Provisional Patent Application No. 63/805,897 by ABEDINI et al., entitled “Autonomous Physical Random Access Channel Power Control,” filed May 14, 2025, assigned to the assignee hereof, and expressly incorporated by reference herein.

### TECHNICAL FIELD

This present disclosure relates generally to wireless communication, and more specifically to systems, devices, methods, and techniques associated with autonomous physical random access channel (PRACH) power control.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:
A method for wireless communications by a user equipment (UE) is described. The method may include receiving a signal that identifies a parameter set associated with power ramping operations during physical random access channel (PRACH) transmissions, where the parameter set includes at least a first subset of power ramping parameters associated with a first PRACH retransmission and a second subset of power ramping parameters associated with a second PRACH retransmission, and where the first subset of power ramping parameters includes one or more parameter values that are different relative to corresponding parameter values of the second subset of power ramping parameters, performing the first PRACH retransmission according to the first subset of power ramping parameters, and performing the second PRACH retransmission according to the second subset of power ramping parameters.

A UE for wireless communications is described. The UE may include a processing system that includes processor circuitry and memory circuitry that stores code. The processing system may be configured to cause the UE to receive a signal that identifies a parameter set associated with power ramping operations during PRACH transmissions, where the parameter set includes at least a first subset of power ramping parameters associated with a first PRACH retransmission and a second subset of power ramping parameters associated with a second PRACH retransmission, and where the first subset of power ramping parameters includes one or more parameter values that are different relative to corresponding parameter values of the second subset of power ramping parameters, perform the first PRACH retransmission according to the first subset of power ramping parameters, and perform the second PRACH retransmission according to the second subset of power ramping parameters.

Another UE for wireless communications is described. The UE may include means for receiving a signal that identifies a parameter set associated with power ramping operations during PRACH transmissions, where the parameter set includes at least a first subset of power ramping parameters associated with a first PRACH retransmission and a second subset of power ramping parameters associated with a second PRACH retransmission, and where the first subset of power ramping parameters includes one or more parameter values that are different relative to corresponding parameter values of the second subset of power ramping parameters, means for performing the first PRACH retransmission according to the first subset of power ramping parameters, and means for performing the second PRACH retransmission according to the second subset of power ramping parameters.

A non-transitory computer-readable medium storing code for wireless communications is described. The code may include instructions executable by one or more processors to receive a signal that identifies a parameter set associated with power ramping operations during PRACH transmissions, where the parameter set includes at least a first subset of power ramping parameters associated with a first PRACH retransmission and a second subset of power ramping parameters associated with a second PRACH retransmission, and where the first subset of power ramping parameters includes one or more parameter values that are different relative to corresponding parameter values of the second subset of power ramping parameters, perform the first PRACH retransmission according to the first subset of power ramping parameters, and perform the second PRACH retransmission according to the second subset of power ramping parameters.

In some examples of the method, user equipment (UEs), and non-transitory computer-readable medium described herein, the first subset of power ramping parameters, the second subset of power ramping parameters, or both, include a maximum transmit power level, an initial preamble transmit power level, a power ramping step size, reference signal received power (RSRP) thresholds (e.g., reference signal received strength thresholds), a maximum quantity of preamble transmissions, scaling factors, a maximum step size, a minimum step size, a step size range of values, a maximum accumulated step size value, or a combination thereof.

In some examples of the method, user equipment (UEs), and non-transitory computer-readable medium described herein, the parameter set includes power ramping parameters that include common values across all synchronization signal block (SSB) beams configured for the UE or that include different values for at least a portion of the SSB beams configured for the UE.

In some examples of the method, user equipment (UEs), and non-transitory computer-readable medium described herein, the parameter set includes power ramping parameters that include common values across all PRACH occasions (ROs) associated with the PRACH transmissions or that include different values for at least a portion of the ROs associated with the PRACH transmissions.

A method for wireless communications by a network entity is described. The method may include transmitting, to a UE, a signal that identifies a parameter set associated with power ramping operations during PRACH transmissions, where the parameter set includes at least a first subset of power ramping parameters associated with a first PRACH retransmission and a second subset of power ramping parameters associated with a second PRACH retransmission, and where the first subset of power ramping parameters includes one or more parameter values that are different relative to corresponding parameter values of the second subset of power ramping parameters, monitoring for the first PRACH retransmission according to the first subset of power ramping parameters, and monitoring for the second PRACH retransmission according to the second subset of power ramping parameters.

A network entity for wireless communications is described. The network entity may include a processing system that includes processor circuitry and memory circuitry that stores code. The processing system may be configured to cause the network entity to transmit, to a UE, a signal that identifies a parameter set associated with power ramping operations during PRACH transmissions, where the parameter set includes at least a first subset of power ramping parameters associated with a first PRACH retransmission and a second subset of power ramping parameters associated with a second PRACH retransmission, and where the first subset of power ramping parameters includes one or more parameter values that are different relative to corresponding parameter values of the second subset of power ramping parameters, monitor for the first PRACH retransmission according to the first subset of power ramping parameters, and monitor for the second PRACH retransmission according to the second subset of power ramping parameters.

Another network entity for wireless communications is described. The network entity may include means for transmitting, to a UE, a signal that identifies a parameter set associated with power ramping operations during PRACH transmissions, where the parameter set includes at least a first subset of power ramping parameters associated with a first PRACH retransmission and a second subset of power ramping parameters associated with a second PRACH retransmission, and where the first subset of power ramping parameters includes one or more parameter values that are different relative to corresponding parameter values of the second subset of power ramping parameters, means for monitoring for the first PRACH retransmission according to the first subset of power ramping parameters, and means for monitoring for the second PRACH retransmission according to the second subset of power ramping parameters.

A non-transitory computer-readable medium storing code for wireless communications is described. The code may include instructions executable by one or more processors to transmit, to a UE, a signal that identifies a parameter set associated with power ramping operations during PRACH transmissions, where the parameter set includes at least a first subset of power ramping parameters associated with a first PRACH retransmission and a second subset of power ramping parameters associated with a second PRACH retransmission, and where the first subset of power ramping parameters includes one or more parameter values that are different relative to corresponding parameter values of the second subset of power ramping parameters, monitor for the first PRACH retransmission according to the first subset of power ramping parameters, and monitor for the second PRACH retransmission according to the second subset of power ramping parameters.

In some examples of the method, network entities, and non-transitory computer-readable medium described herein, the first subset of power ramping parameters, the second subset of power ramping parameters, or both, include a maximum transmit power level, an initial preamble transmit power level, a power ramping step size, RSRP thresholds, a maximum quantity of preamble transmissions, scaling factors, a maximum step size, a minimum step size, a step size range of values, a maximum accumulated step size value, or a combination thereof.

In some examples of the method, network entities, and non-transitory computer-readable medium described herein, the parameter set includes power ramping parameters that include common values across all SSB beams configured for the UE or that include different values for at least a portion of the SSB beams configured for the UE.

### BRIEF DESCRIPTION OF THE DRAWINGS

FIG. 1 shows an example of a wireless communication system.

FIG. 2 shows an example of a signaling diagram that supports autonomous physical random access channel (PRACH) power control.

FIG. 3 shows an example of a resource configuration that supports autonomous PRACH power control.

FIG. 4 shows an example of a method that supports autonomous PRACH power control.

FIG. 5 shows a block diagram of a processing system that supports autonomous PRACH power control.

FIG. 6 shows a diagram of a system including a device that supports autonomous PRACH power control.

FIG. 7 shows a block diagram of a processing system that supports autonomous PRACH power control.

FIG. 8 shows a diagram of a system including a device that supports autonomous PRACH power control.

FIGS. 9 and 10 show flowcharts illustrating methods that support autonomous PRACH power control.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, initial access operations may enable user equipment (UE) to establish a wireless connection with the network. This may include the UE performing physical random access channel (PRACH) operations by transmitting a PRACH preamble to the network. This may trigger a two-step PRACH procedure or a four-step PRACH procedure between the UE and the wireless network to establish the wireless network. Some wireless networks may configure the UE with various parameters to be used during the PRACH procedure, such as power ramping operation parameters. For example, the UE may use the power ramping parameters to perform the initial PRACH preamble transmission and then, if unsuccessful, ramping up the transmit power level from a retransmission. However, such networks generally configure one set of power ramping parameters for the UE, which are applied for each retransmission.

Aspects of the subject matter described in this disclosure relate to improved power ramping operations during a PRACH procedure between a UE and the wireless network. For example, the parameter set configured for the UE to use during the PRACH operations may include power ramping parameters that differ depending on which retransmission the UE is performing. For example, the network entity may transmit (and the UE may receive) a signal that indicates or otherwise identifies a parameter set associated with the power ramping operations during the PRACH transmissions. However, the parameter set may include at least a first subset of power ramping parameters associated with a first PRACH retransmission (ReTx) and a second subset of power ramping parameters associated with a second PRACH retransmission (e.g., per-retransmission power ramping parameters). For example, the parameter value(s) associated with the first subset of power ramping parameters may be set to different values relative to the corresponding parameter value(s) associated with the second subset of power ramping parameters. Accordingly, the UE may perform the first PRACH retransmission according to the first subset of power ramping parameters and perform the second PRACH retransmission according to the second subset of power ramping parameters.

Particular aspects of the subject matter described in this disclosure can be implemented to realize one or more of the following potential advantages. In some examples, by configuring per-retransmission power ramping parameters, the described techniques can be used to improve the initial access procedure between UE and the wireless network. The varying parameter values between the different subset of power ramping parameters may enable more intelligent and nuanced PRACH (re)transmissions by the UE.

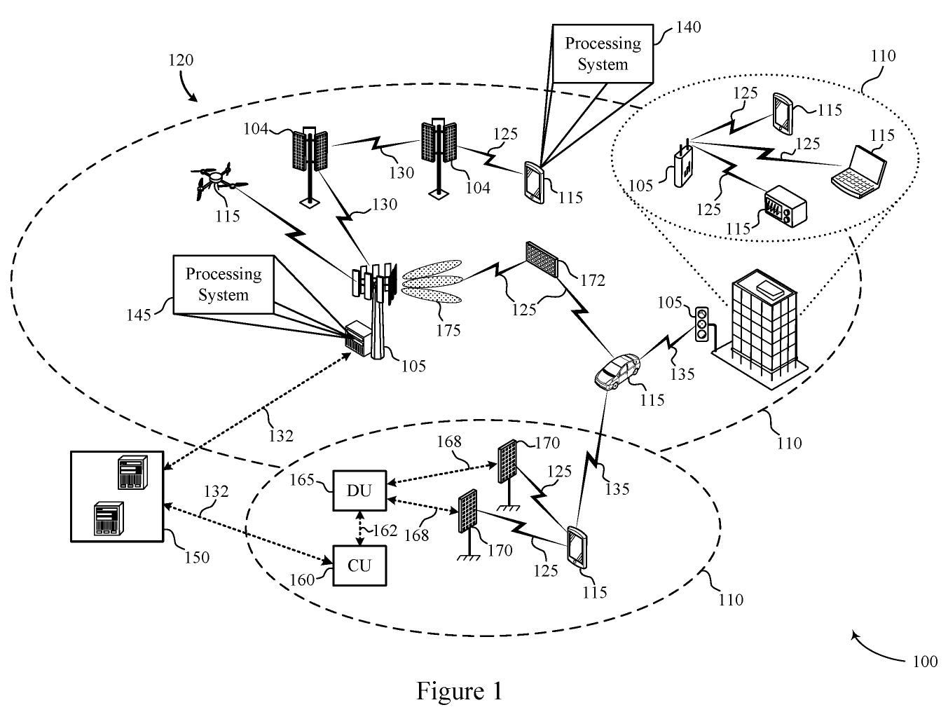

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105 and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration) or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for autonomous PRACH power control. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication system 100 (such as the RAN 120) may support improved PRACH operations between the UE 115 and the network entity 105.

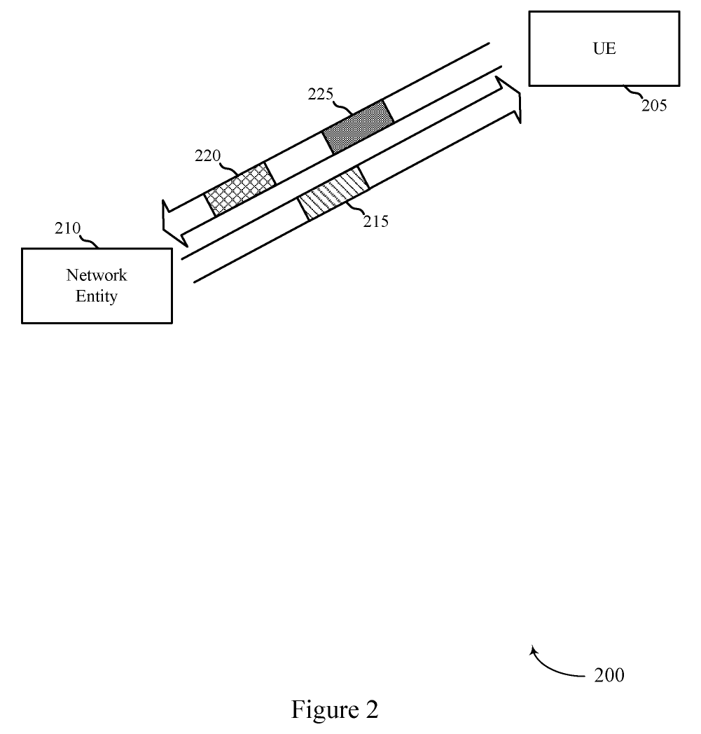

FIG. 2 shows an example of a signaling diagram 200 that supports autonomous PRACH power control. Aspects of the signaling diagram 200 may implement aspects of and/or be implemented by aspects of the wireless communication system 100. Aspects of the signaling diagram 200 may be implemented at and/or implemented by a UE 205 and a network entity 210, which may be examples of the corresponding devices described herein.

Wireless networks may support various types and/or features with respect to UEs. For example, the number and accumulated traffic by fixed wireless access (FWA) and/or customer premise equipment (CPE) device types within a wireless network may generally be increasing. The CPE devices are generally more powerful (e.g., they can support higher transmit power levels) than other wireless devices. Moreover, the CPE devices may generally be stationary with relatively stable channel conditions. Some wireless networks may support simplification of the access procedure for such CPE devices. This may be based on reducing the signaling and/or time for each (re)connection in order to reduce the associated overhead on the network side (such as when there are many CPE devices being deployed). For example, because of the aggregated traffic of such CPE devices, a cell may be heavily loaded at times (e.g., during the afternoon hours, when people are at home, etc.). Accordingly, speeding up the (re)connection procedure, if possible (e.g., given that the characteristics of CPE devices, such as high-power and stationary), may be beneficial to improve the communication key performance indicators (KPIs) and user experience.

In some wireless networks, PRACH transmit power levels may be based on parameters being configured for the UE (e.g., indicated in one or more system information block (SIB) messages). In some examples, such configured parameters include a target receive PRACH power (e.g., for the initial PRACH transmission), a transmit power ramping step, a maximum quantity of retransmissions, and the like. In some networks, a CPE-UE may be configured or otherwise indicated with a transmit power level (e.g., rather than the target receive power) for PRACH transmissions. This may include support for configuring an alpha factor pathloss compensation (e.g., for PRACH transmissions). The CPE-UE may start with a high transmit power level and then ramp down the transmit power level (e.g., based on the configuration provided by the network). In some networks, this may be based on a flexible PRACH configuration (e.g., artificial intelligence (AI)-native) where the UE can choose a flexible value within an indicated minimum-maximum range for various PRACH-related parameters (e.g., initial preamble transmit power, power ramping step, reference signal received power (RSRP) thresholds (e.g., reference signal received strength thresholds), maximum quantity of preamble transmissions, scaling factors, etc.).

Accordingly, aspects of the techniques described herein provide for various enhancements for a PRACH transmission power configuration. Although the described techniques may be applicable to such FWA/CPE devices, it is to be understood that such techniques are not limited to such devices and may be equally applicable to any other wireless device type. The described techniques may be based on the context of flexible and/or AI-native PRACH transmit power configuration and associated details. Aspects of the described techniques may be based on the UE being indicated with various power ramping parameter values for PRACH retransmissions where such parameters may be common for all of the retransmissions or may depend on the retransmission order.

For example, at 215 the network entity 210 may transmit or otherwise output (and the UE 205 may receive or otherwise obtain) a signal that identifies a parameter set associated with power ramping operations during PRACH transmissions. For example, the parameter set may include a first subset of power ramping parameters associated with a first PRACH retransmission and a second subset of power ramping parameters associated with a second PRACH retransmission. However, parameter value(s) of the first subset of power ramping parameters may be different from the corresponding parameter value(s) of the second subset of power ramping parameters.

The UE 205 may initiate a connection (re)establishment procedure with the network entity 210. For example, the UE 205 may initiate the connection (re)establishment procedure by transmitting a PRACH preamble to the network entity 210. The PRACH preamble may be a PRACH message one (Msg1) in a four-step PRACH procedure or may be a PRACH message A (MsgA) in a two-step PRACH procedure. The network entity 210 may respond to the PRACH preamble by transmitting a random access response (RAR) message to the UE 205. The RAR may be referred to as a PRACH message two (Msg2) in the four-step PRACH procedure or as a PRACH message B (MsgB) in the two-step PRACH procedure. In the four-step PRACH procedure, the UE 205 may then transmit a PRACH message three (Msg3) to the network entity 210, which follows up with a PRACH message four (Msg4) to the UE 205.

However, in some cases one or more of the transmissions from the UE 205 may be repeated (e.g., in one or more retransmissions). For example, at 220 the UE 205 may perform the first PRACH retransmission according to the first subset of power ramping parameters and, at 225, the UE 205 may perform the second PRACH retransmission according to the second subset of power ramping parameters. The PRACH retransmissions may correspond to retransmission(s) of the PRACH preamble and/or of the PRACH Msg3.

That is, the UE 205 may initially perform a PRACH transmission (e.g., a PRACH preamble transmission) to the network entity 210 according to the parameter set. However, the UE 205 may perform one or more retransmissions of the PRACH preamble or another PRACH message to the network entity 210. The UE 205 may perform the first PRACH retransmission according to the first subset of power ramping parameters (e.g., using the parameter values of the first subset of power ramping parameters). The UE 205 may then perform another PRACH retransmission to the network entity 210. However, the UE 205 may perform this second PRACH retransmission according to the second subset of power ramping parameters. As discussed, the parameter value(s) in the first subset of power ramping parameters may be set to different values than the corresponding parameter value(s) in the second subset of power ramping parameters. This may improve the reception of the first PRACH retransmission and/or of the second PRACH retransmission.

For example, the UE 205 may be indicated with the parameter set that includes a variety of power ramping parameters (e.g., values for the power ramping parameters). One such parameter may include a maximum transmit power level (e.g., can be set to infinity or to no limit) where the UE 205 is allowed to flexibly choose its transit power level for the PRACH (re)transmission within a given range. Other such parameters may include an initial preamble transmit power level, a power ramping step, RSRP thresholds, a maximum quantity of preamble transmissions, scaling factors, and the like. Another example of such parameters may include a maximum step size, a minimum step size, and/or a range of values for the power ramping step sizes. Yet another example of such parameters may include a maximum value for the accumulated step sizes (e.g., the maximum power increase with respect to the initial transmission power level used for the first PRACH transmission) and/or a minimum value or range of such values.

Accordingly, any such parameters may be common (e.g., have the same values) for all of the PRACH retransmissions or all or some of these parameters may depend on the retransmission order. For example, the power ramping parameter values associated with the accumulated step size may be based on the retransmission order. As one example, a transmit power level for a third retransmission (P3) may be set to <= P1 plus a maximum delta 3 (P3≤P1+maxDelta3), a transmit power level for a fourth retransmission (P4) may be set to <= P1 plus a maximum delta four (P4≤P1+maxDelta4), where P1 is the transmit power level of the first PRACH transmission (e.g., the PRACH preamble initial transmission).

Thus, in some aspects, the first subset of power ramping parameters and/or the second subset of power ramping parameters may include a maximum transmit power level, an initial preamble transmit power level, a power ramping step size, RSRP thresholds, a maximum quantity of preamble transmissions, scaling factors, a maximum step size, a minimum step size, a step size range of values, and/or a maximum accumulated step size value.

In some aspects, the parameter set may include power ramping parameters that are common values across all synchronization signal block (SSB) beams configured for the UE 205 and/or may include different values for at least a portion of the SSB beams configured for the UE 205. For example, any of the power ramping parameters can be commonly configured for all SSB beams or different values may be configured and/or otherwise indicated for different groups of one or more SSB beams. The first subset of power ramping parameters may include parameter value(s) that are different parameter values than in the second subset of power ramping parameters for different SSB beams (e.g., beams used for SSB transmissions and/or receptions).

In some aspects, the parameter set may include power ramping parameters that include common values across all PRACH occasions (ROs) associated with the PRACH transmissions or that include different values for at least a portion of the ROs associated with the PRACH transmissions. That is, any of the power ramping parameters can be commonly configured for all ROs or different values may be configured or otherwise indicated for different ROs. As one example, the power ramping parameters may be associated with half duplex (HD) vs gNB-full duplex (FD)/gNB-subband full duplex (SBFD) vs UE-FD/UE-SBFD occasions. As another example, the power ramping parameters may be associated with baseline ROs vs extra ROs that may be (de)activated (such as is used in the context of network energy saving (NES) operations). As another example, the power ramping parameters may be associated with different features and/or with different types of UEs.

In some aspects, the parameter set may include power ramping parameters that include common values across a group of cells associated with the UE 205 and/or a group of one or more frequencies associated with the UE 205. That is, any of the proposed power ramping parameters can be commonly configured or indicated for a group of cells, for a group of one or multiple frequencies, and/or for an area associated with the UE 205 (such as a tracking area or paging area).

In some aspects, the signal that identifies the parameter set may include various signaling types transmitted by the network entity 210 to the UE 205. For example, the signal may include a SIB message, a dedicated RRC message, a DCI message, a paging message, a PDCCH message, a PDSCH message, a wakeup signal (WUS), a medium access control-control element (MAC-CE) message, and/or a PRACH message two (Msg2). For example, the indication of the parameter set may be provided via any combination of SIB, dedicated RRC, and/or more dynamic indications/adjustments (e.g., via DCI/paging early indication (PEI)/paging PDCCH or PDSCH/WUS/MAC-CE, RACH Msg2, etc.).

In some aspects, the parameter set may be based on a UE type associated with the UE 205 and/or based on a feature associated with the UE 205. That is, the features described herein may be supported or otherwise enabled for some types of UEs (e.g., CPE-UEs, reduced capability (RedCap) UEs, etc.) and/or features. In some cases, the indication of such support may be provided via SIB messaging, dedicated RRC signaling, and/or via OAM signaling.

In some aspects, the UE 205 may transmit or otherwise output (and the network entity 210 may receive or otherwise obtain) information that identifies requested power ramping parameter(s). In this aspect, the parameter set may be based on the requested power ramping parameter(s). For example, the UE 205 may suggest values and/or a range of values for the parameter set. The information may be transmitted or otherwise indicated by the UE 205 via RRC signaling and/or via other signaling (e.g., UCI signaling, PUCCH signaling, PUSCH signaling, via MAC-CE signaling, etc.).

In some aspects, the UE 205 may transmit or otherwise output (and the network entity 210 may receive or otherwise obtain) a report that identifies metric(s) associated with the PRACH transmissions. The metric(s) may be based on the first subset of power ramping parameters and/or on the second subset of power ramping parameters. For example, the UE 205 may report (e.g., after the initial access procedure) any of the following information to the network. The metric(s) indicated in the report may include the quantity of (re)transmissions performed for accessing the cell (or prior cells with unsuccessful access). The metric(s) indicated in the report may include the power ramping set values, the accumulated values, and/or the maximum values (e.g., for the last transmission). The metric(s) indicated in the report may include the initial transmit power level and/or pathloss estimation. The metric(s) indicated in the report may include the sequence of estimated pathloss values for multiple (re)transmissions. One or more techniques described herein (e.g., suggestion of values or ranges of values for the parameter set, transmitting or outputting a report, among other features) may result in real-time network adjustments, enhance efficiency, as well as reduce signaling overhead.

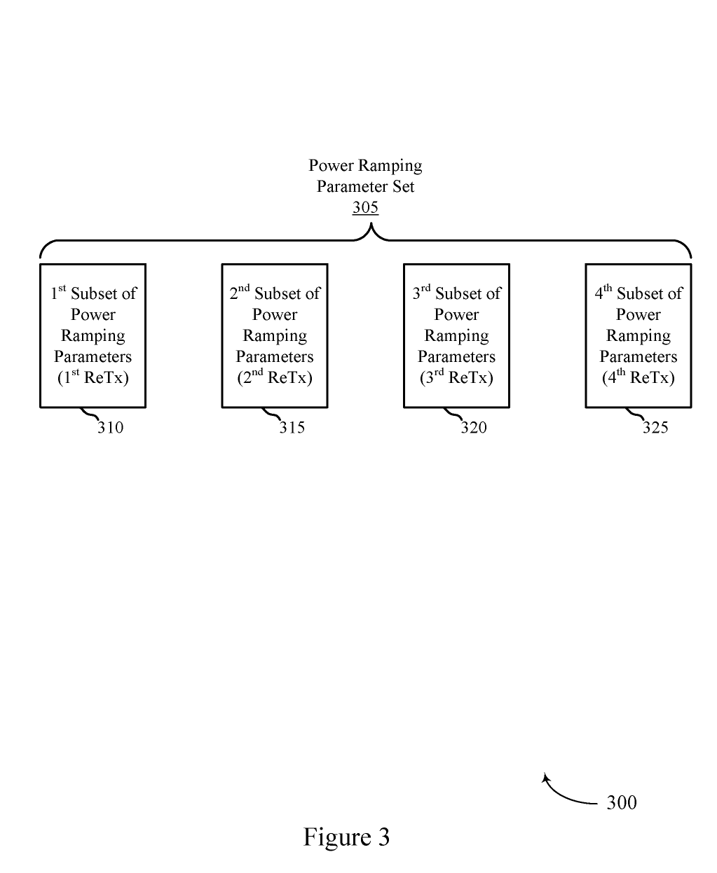

FIG. 3 shows an example of a resource configuration 300 that supports autonomous PRACH power control. Aspects of the resource configuration 300 may implement aspects of and/or be implemented by aspects of the wireless communication system 100 and/or the signaling diagram 200. Aspects of the resource configuration 300 may be implemented at and/or implemented by a UE or a network entity, which may be examples of the corresponding devices described herein.

Aspects of the described techniques may support a network configuring power ramping parameter values in a manner where different parameter values are used for different PRACH retransmissions. For example, the network entity may transmit or otherwise output (and the UE may receive or otherwise obtain) a signal that carries or otherwise conveys information that identifies a parameter set 305. The parameter set 305 may be associated with power ramping operations during PRACH (re)transmissions. For example, the parameter set 305 may include a first subset of power ramping parameters 310 associated with a first PRACH retransmission and a second subset of power ramping parameters 315 associated with a second PRACH retransmission. In the example shown in FIG. 3, the parameter set 305 also includes a third subset of power ramping parameters 320 associated with a third PRACH retransmission and a fourth subset of power ramping parameters 325 associated with a fourth PRACH retransmission.

In some aspects, one or more of the different subsets of power ramping parameters may have different parameter values than the corresponding values in the other subset(s) of power ramping parameters. As one example, the individual values and/or range of values for the various parameters in the first subset of power ramping parameters 310 may be different from the corresponding values and/or range of values in the other subsets of power ramping parameters. As another example, the individual values and/or range of values for the various parameters in the first subset of power ramping parameters 310 and in the second subset of power ramping parameters 315 may be different from the corresponding values and/or range of values in the third subset of power ramping parameters 320 and in the fourth subset of power ramping parameters 325. Thus, various parameter configurations and/or groupings of the power ramping parameters may be supported for PRACH retransmissions by the UE.

The UE may initiate the PRACH procedure for the connection (re)establishment with the network (e.g., via PRACH preamble transmissions). The UE may perform one or more PRACH retransmission(s) during the PRACH procedure according to the parameter set 305. For example, the UE may perform a first PRACH retransmission according to the first subset of power ramping parameters 310. The UE may perform a second PRACH retransmission according to the second subset of power ramping parameters 315. The UE may perform a third PRACH retransmission according to the third subset of power ramping parameters 320. And finally, the UE may perform a fourth PRACH retransmission according to the fourth subset of power ramping parameters 325. As discussed, each PRACH retransmission may be performed according to the retransmission order (e.g., according to the corresponding subset of power ramping parameters for a given retransmission).

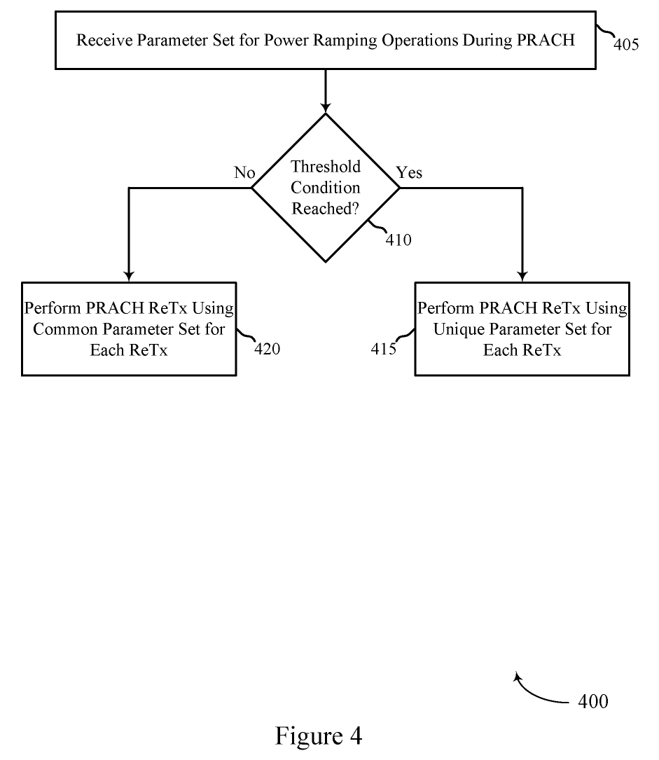

FIG. 4 shows an example of a method 400 that supports autonomous PRACH power control. Aspects of the method 400 may implement aspects of and/or may be implemented by aspects of the wireless communication system 100, the signaling diagram 200, and/or the resource configuration 300. Aspects of the method 400 may be implemented at and/or may be implemented by aspects of a UE and/or a network entity, which may be examples of the corresponding devices described herein.

At 405, the UE may receive a signal that identifies a parameter set associated with power ramping operations during PRACH transmissions. For example, the parameter set may include at least a first subset of power ramping parameters that are associated with a first PRACH retransmission and a second subset of power ramping parameters that are associated with a second PRACH retransmission. However, one or more of the individual parameter values in the first subset of power ramping parameters may be different relative to the corresponding parameter values in the second subset of power ramping parameters. That is, the parameter set that the UE uses for PRACH retransmissions during the PRACH procedure may be configured or otherwise indicated with unique values on a per-retransmission basis. This may enable the UE to more flexibly adapt the PRACH retransmission parameters for reduced channel access latency.

At 410, the UE may identify or otherwise determine whether a threshold condition has been satisfied. That is, in some cases the UE may apply the parameter set during the PRACH procedure based on an occurrence of a threshold condition associated with the UE. Thus, in some cases some conditions may be configured or otherwise indicated to the UE based on which the UE can determine whether it can use the parameter set and/or which associated values or range of values the UE should apply. One threshold condition may be based on the UE’s mobility state (e.g., whether or not the UE is stationary, and if mobile, it may depend on the level of mobility such that different levels of mobility may be defined based on various aspects such as the amount and/or rate of change of channel strength or quality, quantity of cell and/or beam reselections within a time interval, actual speed, etc.). Another threshold condition may be based on amount of change or drift in the measured or observed downlink receive timing.

Another threshold condition may be based on some timers (e.g., a timer may be started at the time of releasing to the idle or inactive state, or a timer can be an uplink timing advance timer, a new timer, the timer can be started based on an explicit indication from the network even in the idle or inactive state, etc.). Another threshold condition may be based on an explicit indication from the network (e.g., in a paging or wake-up signal or in a PRACH Msg2). Another threshold condition may be based on the cause for the UE sending RACH (e.g., the PRACH preamble) and/or based on a predicted type or amount of traffic, or an associated quality of service (QoS), such as related to a delay requirement or delay status. Another threshold condition may be based on the UE’s battery and/or power-related levels or conditions. Another threshold condition may be based on the location of the UE (e.g., where the location can be an RF distance in terms of RSRP thresholds, or areas, zones, geo-locations, etc.). Another threshold condition may be based on the load on the cell (e.g., information regarding the cell load can be acquired from unified access control (UAC) signaling, or through other signaling means. Another threshold condition may be based on the mobility state of the cell (e.g., relatively stationary or mobile).

If the threshold condition has been reached, at 415 the UE may perform PRACH retransmissions using the unique parameter set values for each PRACH retransmission. For example, the UE may perform a first PRACH retransmission according to the first subset of power ramping parameters and then perform a second PRACH retransmission according to the second subset of power ramping parameters.

If the threshold condition has not been reached, at 420 the UE may perform PRACH retransmissions using common parameter set values for each PRACH retransmission. That is, the feature related to PRACH retransmissions where each PRACH retransmission may be performed to unique power ramping parameter values based on the retransmission order may be enabled or disabled based on whether or not the threshold condition has been reached or otherwise satisfied.

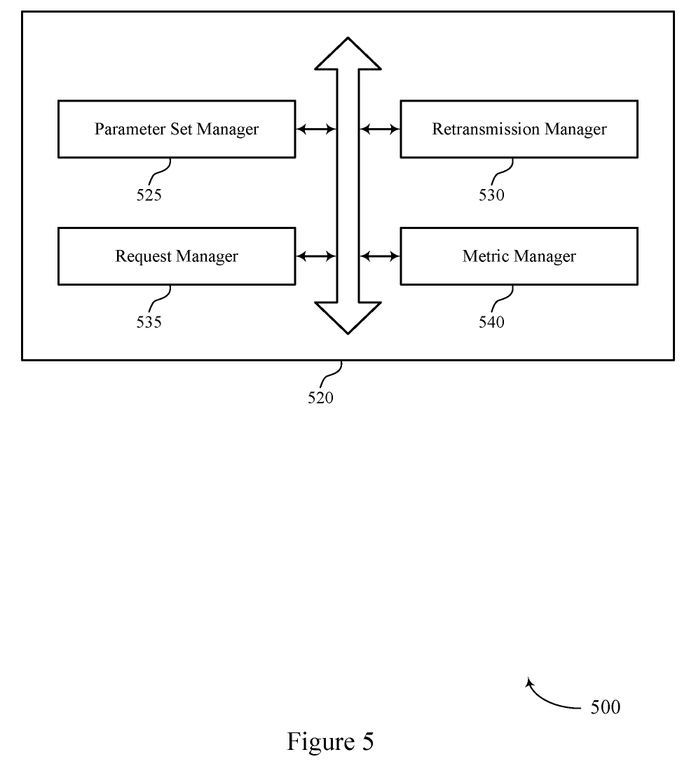

FIG. 5 shows an example 500 of a processing system 520 that supports autonomous PRACH power control. A processing system 520 may be an example of a processing system 140 (such as of a UE 115) and may include a parameter set manager 525, a retransmission manager 530, a request manager 535, a metric manager 540, or any combination thereof. A processing system 520, or various component thereof, may be an example of means for performing (such as a means for causing a UE 115 to perform) various techniques described herein.

The parameter set manager 525 may be configured to cause the UE 115 to receive a signal that identifies a parameter set associated with power ramping operations during PRACH transmissions, where the parameter set includes at least a first subset of power ramping parameters associated with a first PRACH retransmission and a second subset of power ramping parameters associated with a second PRACH retransmission, and where the first subset of power ramping parameters includes one or more parameter values that are different relative to corresponding parameter values of the second subset of power ramping parameters. The retransmission manager 530 may be configured to cause the UE 115 to perform the first PRACH retransmission according to the first subset of power ramping parameters. In some examples, the retransmission manager 530 may be configured to cause the UE 115 to perform the second PRACH retransmission according to the second subset of power ramping parameters.

In some examples, the first subset of power ramping parameters, the second subset of power ramping parameters, or both, include a maximum transmit power level, an initial preamble transmit power level, a power ramping step size, RSRP thresholds, a maximum quantity of preamble transmissions, scaling factors, a maximum step size, a minimum step size, a step size range of values, a maximum accumulated step size value, or a combination thereof. In some examples, the parameter set includes power ramping parameters that include common values across all SSB beams configured for the UE or that include different values for at least a portion of the SSB beams configured for the UE. In some examples, the parameter set includes power ramping parameters that include common values across all ROs associated with the PRACH transmissions or that include different values for at least a portion of the ROs associated with the PRACH transmissions.

In some examples, the parameter set includes power ramping parameters that include common values across a group of cells associated with the UE, a group of one or more frequencies associated with the UE, a location area associated with the UE, or a combination thereof. In some examples, the signal that identifies the parameter set includes an SIB message, an RRC message, a DCI message, a paging message, a PDCCH message, a PDSCH message, a wakeup signal, a MAC-CE message, a PRACH message two (Msg2), or a combination thereof. In some examples, application of the parameter set is based on a UE type associated with the UE, on a feature associated with the UE, or both. In some examples, application of the parameter set is based on an occurrence of a threshold condition associated with the UE.

In some examples, the request manager 535 may be configured to cause the UE 115 to transmit information that identifies one or more requested power ramping parameters, where the parameter set is based on the one or more requested power ramping parameters.

In some examples, the metric manager 540 may be configured to cause the UE 115 to transmit a report that identifies one or more metrics associated with the PRACH transmissions, where the one or more metrics are based on the first subset of power ramping parameters, the second subset of power ramping parameters, or both.

A processing system 520 may include or be a component of one or more chips, systems-on-chips (SoCs), chipsets, packages, components, or devices that individually or collectively constitute or include a processing system. A processing system 520 may interface with other components of a processing system 520. For example, operations described with reference to a processing system 520, or various components thereof, may be performed by or with other such components, including a receiver, a transmitter, a transceiver, a modem, a user interface, a modulator/demodulator, an encoder/decoder, or any combination thereof (such as of the processing system 520, coupled with the processing system 520, of a processing system 520).

By including or configuring a processing system 520 for operation in a processing system 520 as described herein, the processing system 520 may support techniques for improved power ramping operations during PRACH retransmissions. This may include configuring the UE with per-PRACH retransmission power ramping parameter values that provide more flexibility and intelligence in the PRACH retransmissions by the UE.

In some cases, the parameter set manager 525, the retransmission manager 530, the request manager 535, and/or the metric manager 540, may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the parameter set manager 525, the retransmission manager 530, the request manager 535, and/or the metric manager 540, discussed herein.

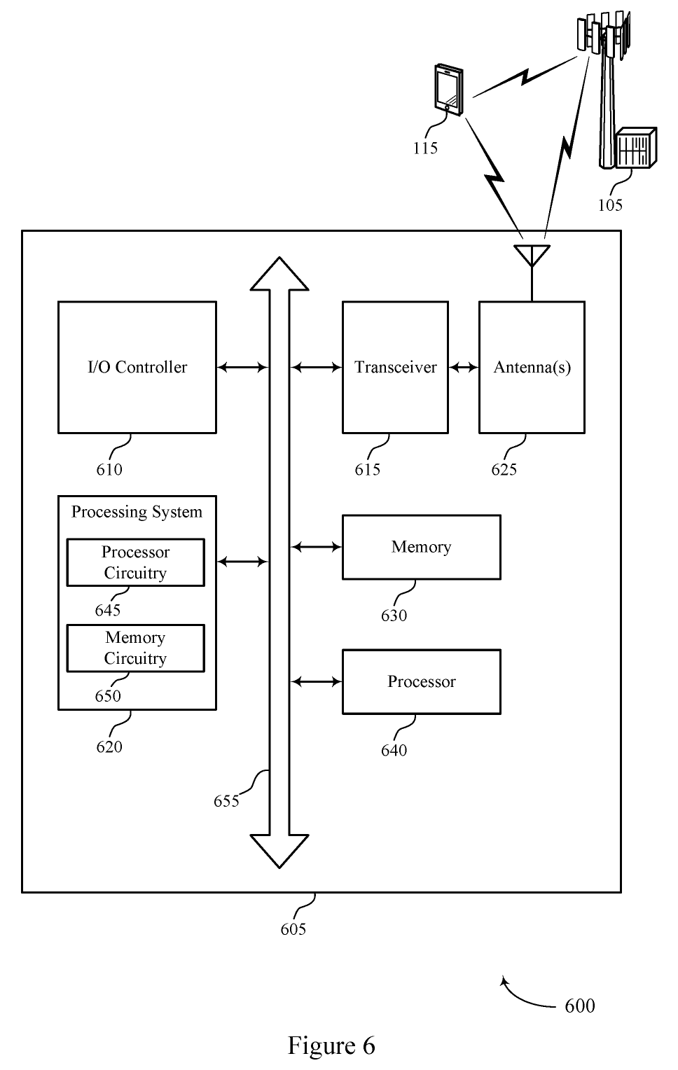

FIG. 6 shows an example of a system 600 including a device 605 that supports autonomous PRACH power control. The device 605 may be an example of or include components of UE 115. The device 605 may communicate (such as wirelessly) with one or more other devices (such as network entities 105, UEs 115). The device 605 may include components for transmitting and receiving communication, which may include a processing system 620, an input/output (I/O) controller, such as an I/O controller 610, a transceiver 615, antenna(s) 625, a memory 630, and a processor 640. Components of the device 605 may be coupled (such as operatively, communicatively, functionally, electronically, electrically, in electronic communication) via a bus 655.

The transceiver 615 may support bi-directional communication via antenna(s) 625, and may support transmission operations, reception operations, or both, as described herein. The transceiver 615 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 605). The transceiver 615 may modulate symbols and provide the modulated symbols to antenna(s) 625 for transmission, and demodulate symbols from signals received using antenna(s) 625.

The processor 640 may be a general-purpose processing component that supports various operations (such as applications) of the device 605. The memory 630 may be a general-purpose storage component that stores code executable by the processor 640. Such code may include instructions that, when executed by the processor 640, cause the device 605 to perform various functions (such as to support an application of the device 605). The I/O controller 610 may manage inputs and outputs for the device 605, may manage peripherals not integrated into the device 605, or may represent a physical connection (such as port) to an external peripheral. The processor 640 may interact with a modem, a keyboard, a mouse, a touchscreen, or other device (such as via I/O controller 610). In some implementations, a user may interact with the device 605 via the I/O controller 610 or via hardware components controlled by the I/O controller 610.

The processing system 620 may be an example of a processing system 140 or a processing system 520. For example, the processing system 620 may include processor circuitry 645 and memory circuitry 650 that stores code, and may be configured to cause the device 605 to perform operations that support autonomous PRACH power control. Although the processing system 620 is illustrated as a separate component, which may involve a separate chip, chipset, or other module, in some implementations, one or more functions described with reference to the processing system 620 may be supported by or performed by a transceiver 615, antenna(s) 625, a processor 640, memory 630, or any combination thereof, such that a processing system 620 may include one or more of a transceiver 615, antenna(s) 625, a processor 640, memory 630, or any combination thereof.

By including or configuring the processing system 620 for operation in the device 605 as described herein, the device 605 and/or the processing system 620 may support techniques for improved power ramping operations during PRACH retransmissions. This may include configuring the UE with per-PRACH retransmission power ramping parameter values that provide more flexibility and intelligence in the PRACH retransmissions by the UE.

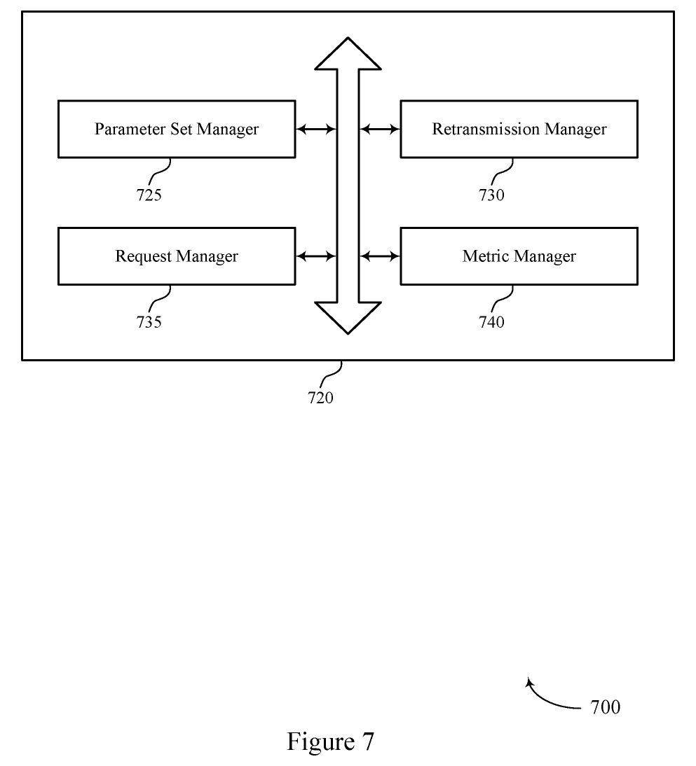

FIG. 7 shows an example 700 of a processing system 720 that supports autonomous PRACH power control. A processing system 720 may be an example of a processing system 145 (such as network entity 105) and may include a parameter set manager 725, a retransmission manager 730, a request manager 735, a metric manager 740, or any combination thereof. A processing system 720, or various component thereof, may be an example of means for performing (such as a means for causing a network entity 105 to perform) various techniques described herein.

The parameter set manager 725 may be configured to cause the network entity 105 to transmit, to a UE, a signal that identifies a parameter set associated with power ramping operations during PRACH transmissions, where the parameter set includes at least a first subset of power ramping parameters associated with a first PRACH retransmission and a second subset of power ramping parameters associated with a second PRACH retransmission, and where the first subset of power ramping parameters includes one or more parameter values that are different relative to corresponding parameter values of the second subset of power ramping parameters. The retransmission manager 730 may be configured to cause the network entity 105 to monitor for the first PRACH retransmission according to the first subset of power ramping parameters. In some examples, the retransmission manager 730 may be configured to cause the network entity 105 to monitor for the second PRACH retransmission according to the second subset of power ramping parameters.

In some examples, the first subset of power ramping parameters, the second subset of power ramping parameters, or both, include a maximum transmit power level, an initial preamble transmit power level, a power ramping step size, RSRP thresholds, a maximum quantity of preamble transmissions, scaling factors, a maximum step size, a minimum step size, a step size range of values, a maximum accumulated step size value, or a combination thereof. In some examples, the parameter set includes power ramping parameters that include common values across all SSB beams configured for the UE or that include different values for at least a portion of the SSB beams configured for the UE. In some examples, the parameter set includes power ramping parameters that include common values across all ROs associated with the PRACH transmissions or that include different values for at least a portion of the ROs associated with the PRACH transmissions.

In some examples, the parameter set includes power ramping parameters that include common values across a group of cells associated with the UE, a group of one or more frequencies associated with the UE, a location area associated with the UE, or a combination thereof. In some examples, the signal that identifies the parameter set includes an SIB message, an RRC message, a DCI message, a paging message, a PDCCH message, a PDSCH message, a wakeup signal, a MAC-CE message, a PRACH Msg2, or a combination thereof. In some examples, application of the parameter set is based on a UE type associated with the UE, on a feature associated with the UE, or both. In some examples, application of the parameter set is based on an occurrence of a threshold condition associated with the UE.

In some examples, the request manager 735 may be configured to cause the network entity 105 to receive, from the UE, information that identifies one or more requested power ramping parameters, where the parameter set is based on the one or more requested power ramping parameters.

In some examples, the metric manager 740 may be configured to cause the network entity 105 to receive, from the UE, a report that identifies one or more metrics associated with the PRACH transmissions, where the one or more metrics are based on the first subset of power ramping parameters, the second subset of power ramping parameters, or both.

A processing system 720 may include or be an example of one or more chips, SoCs, chipsets, packages, components, or devices that individually or collectively constitute or include a processing system. A processing system 720 may interface with other components of a network entity 105. For example, operations described with reference to a processing system 720, or various components thereof, may be performed by or with other such components, including a receiver, a transmitter, a transceiver, a modem, a user interface, a modulator/demodulator, an encoder/decoder, or any combination thereof (such as of the processing system 720, coupled with the processing system 720, of a network entity 105). Operations described herein with reference to the processing system 720, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 720 for operation in a processing system 720 as described herein, the processing system 720 may support techniques for improved power ramping operations during PRACH retransmissions. This may include configuring the UE with per-PRACH retransmission power ramping parameter values that provide more flexibility and intelligence in the PRACH retransmissions by the UE.

In some cases, the parameter set manager 725, the retransmission manager 730, the request manager 735, and/or the metric manager 740 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the parameter set manager 725, the retransmission manager 730, the request manager 735, and/or the metric manager 740 discussed herein.

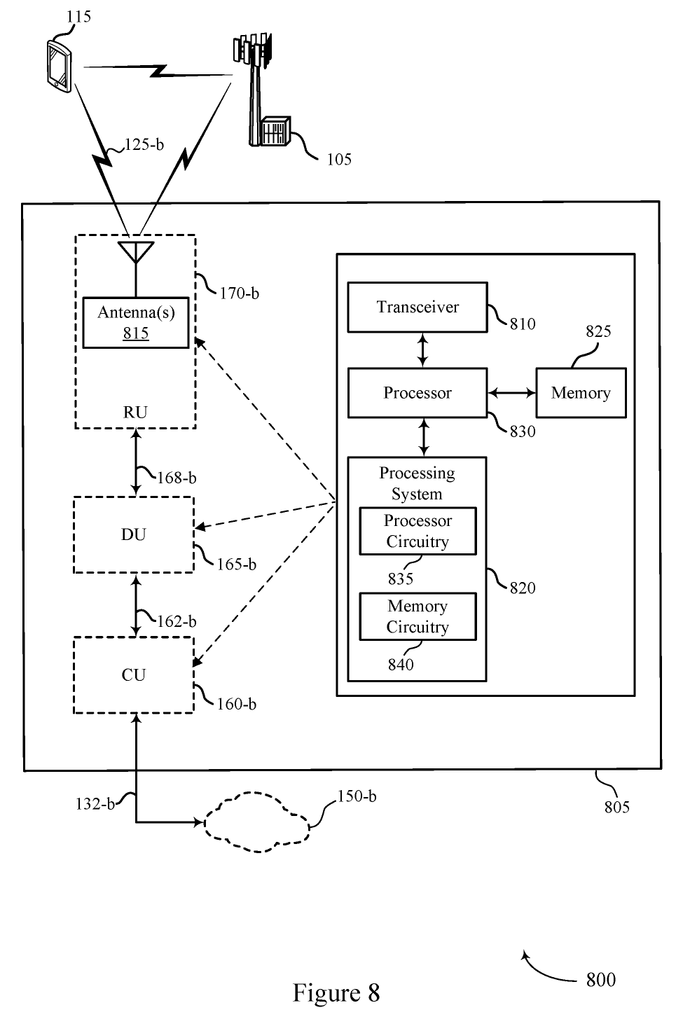

FIG. 8 shows an example of a system 800 including a device 805 that supports autonomous PRACH power control. The device 805 may communicate (such as via one or more wired interfaces or one or more wireless interfaces) with other network devices or network equipment such as a core network 150-b, other network entities 105, UEs 115, or any combination thereof. The device 805 may include components for transmitting and receiving communication, which may include a processing system 820, a transceiver 810, antenna(s) 815, a memory 825, and a processor 830. Components of the device 805 may be coupled (such as operatively, communicatively, functionally, electronically, electrically, in electronic communication) via one or more interfaces.

The transceiver 810 may communicate bi-directionally with another transceiver via wired or wireless links, and may support transmission operations, reception operations, or both, as described herein. The transceiver 810 may include a modem to modulate and demodulate signals, to provide the modulated signals for transmission (such as via antenna(s) 815, via a wired interface), and to demodulate received signals (such as received via antenna(s) 815, received via a wired interface). The transceiver 810 may be operable to support communication via one or more communication links (such as a communication link 125-b, a backhaul link 132-b, a midhaul link 162-b, fronthaul link 168-b).

The processor 830 may be a general-purpose processing component that supports various operations (such as applications) of the device 805. The memory 825 may be a general-purpose storage component that stores code executable by the processor 830. Such code may include instructions that, when executed by the processor 830, cause the device 805 to perform various functions (such as to support an application of the device 805).

For examples in which the device 805 is a network entity 105 in a disaggregated architecture, one or more components of the device 805 may be located at one or more of a CU 160-b, a DU 165-b, or an RU 170-b, one or more of which may include aspects of the processing system 820, the processor 830, the memory 825, or the transceiver 810. Functions of the device 805 may be performed at different components or an operation may be divided between different components (such as different functions being supported by aspects of the CU 160-b, the DU 165-b, or the RU 170-b, the transceiver 810, the processor 830, the memory 825, the processing system 820, or any combination thereof). For example, the processing system 820 may be a component of one or more of the CU 160-b, the DU 165-b, or the RU 170-b. In some examples, interfaces between components of device 805 (such as CU 160-b, DU 165-b, RU 170-b) may support communication at a protocol layer or between protocol layers of a protocol stack.

In some examples, the processing system 820 may manage aspects of communication with the core network 150-b (such as via a backhaul link 132). For example, the processing system 820 may manage the transfer of data communication for UEs 115 with a gateway of the core network 150-b. In some examples, the processing system 820 may manage communication with one or more other network entities 105 and may include a controller or scheduler for controlling communication with UEs 115 (such as in cooperation with the one or more other network entities 105). In some examples, the processing system 820 may support an interface (such as X2 interface, Xn interface) to provide communication between network entities 105.

The processing system 820 may be an example of a processing system 145 or a processing system 720. For example, the processing system 820 may include processor circuitry 835 and memory circuitry 840 that stores code, and the processing system 820 may be configured to cause the device 805 to perform operations that support autonomous PRACH power control. Although the processing system 820 is illustrated as a separate component, which may involve a separate chip, chipset, or other module, in some implementations, one or more functions described with reference to the processing system 820 may be supported by or performed by a transceiver 810, antenna(s) 815, a processor 830, memory 825, or any combination thereof, such that a processing system 820 may include one or more of a transceiver 810, antenna(s) 815, a processor 830, memory 825, or any combination thereof. Further, processor circuitry 835 and memory circuitry 840 each may be implemented at the device 805 in accordance with an aggregated architecture, or the processor circuitry 835 and the memory circuitry 840 may be implemented at one or more of a CU 160-b, a DU 165-b, or an RU 170-b in accordance with a disaggregated architecture.

By including or configuring the processing system 820 for operation in the device 805 as described herein, the device 805 and/or the processing system 820 may support techniques for improved power ramping operations during PRACH retransmissions. This may include configuring the UE with per-PRACH retransmission power ramping parameter values that provide more flexibility and intelligence in the PRACH retransmissions by the UE.

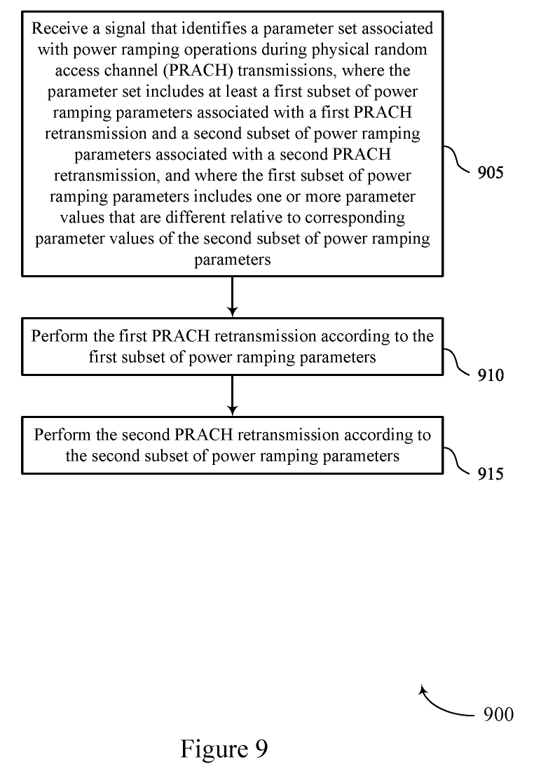

FIG. 9 shows an example of a method 900 that supports autonomous PRACH power control. Operations of the method 900 may be performed by a UE or its components (such as using a processing system configured to cause the UE 115 to perform one or more of the operations) as described herein.

At 905, the method may include receiving a signal that identifies a parameter set associated with power ramping operations during PRACH transmissions, where the parameter set includes at least a first subset of power ramping parameters associated with a first PRACH retransmission and a second subset of power ramping parameters associated with a second PRACH retransmission, and where the first subset of power ramping parameters includes one or more parameter values that are different relative to corresponding parameter values of the second subset of power ramping parameters. In some examples, aspects of the operations of 905 may be performed by a parameter set manager 525.

At 910, the method may include performing the first PRACH retransmission according to the first subset of power ramping parameters. In some examples, aspects of the operations of 910 may be performed by a retransmission manager 530.

At 915, the method may include performing the second PRACH retransmission according to the second subset of power ramping parameters. In some examples, aspects of the operations of 915 may be performed by a retransmission manager 530.

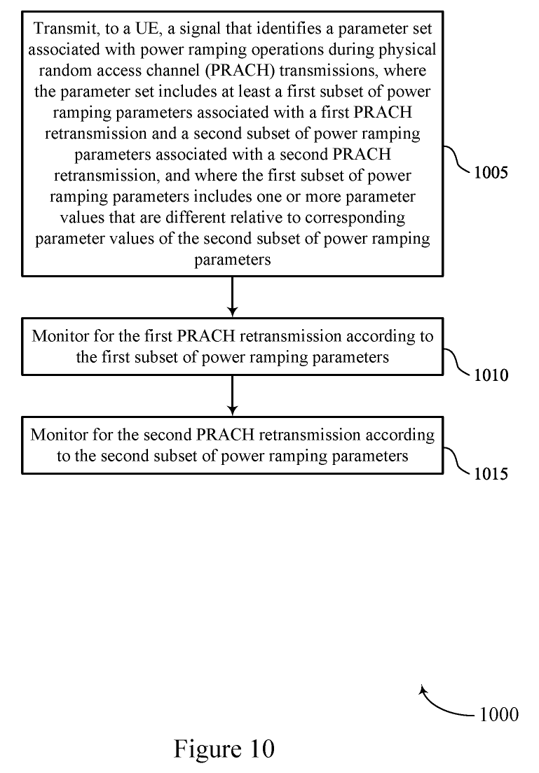

FIG. 10 shows an example of a method 1000 that supports autonomous PRACH power control. Operations of the method 1000 may be performed by a network entity 105 or its components (such as using a processing system configured to cause the network entity to perform one or more operations) as described herein.

At 1005, the method may include transmitting, to a UE, a signal that identifies a parameter set associated with power ramping operations during PRACH transmissions, where the parameter set includes at least a first subset of power ramping parameters associated with a first PRACH retransmission and a second subset of power ramping parameters associated with a second PRACH retransmission, and where the first subset of power ramping parameters includes one or more parameter values that are different relative to corresponding parameter values of the second subset of power ramping parameters. In some examples, aspects of the operations of 1005 may be performed by a parameter set manager 725.

At 1010, the method may include monitoring for the first PRACH retransmission according to the first subset of power ramping parameters. In some examples, aspects of the operations of 1010 may be performed by a retransmission manager 730.

At 1015, the method may include monitoring for the second PRACH retransmission according to the second subset of power ramping parameters. In some examples, aspects of the operations of 1015 may be performed by a retransmission manager 730.

Implementation examples are described in the following numbered clauses:
Aspect 1: A method for wireless communications at a UE, comprising: receiving a signal that identifies a parameter set associated with power ramping operations during PRACH transmissions, wherein the parameter set comprises at least a first subset of power ramping parameters associated with a first PRACH retransmission and a second subset of power ramping parameters associated with a second PRACH retransmission, and wherein the first subset of power ramping parameters comprises one or more parameter values that are different relative to corresponding parameter values of the second subset of power ramping parameters; performing the first PRACH retransmission according to the first subset of power ramping parameters; and performing the second PRACH retransmission according to the second subset of power ramping parameters.
Aspect 2: The method of aspect 1, wherein the first subset of power ramping parameters, the second subset of power ramping parameters, or both, comprise a maximum transmit power level, an initial preamble transmit power level, a power ramping step size, RSRP thresholds, a maximum quantity of preamble transmissions, scaling factors, a maximum step size, a minimum step size, a step size range of values, a maximum accumulated step size value, or a combination thereof.
Aspect 3: The method of any of aspects 1 through 2, wherein the parameter set comprises power ramping parameters that include common values across all SSB beams configured for the UE or that include different values for at least a portion of the SSB beams configured for the UE.
Aspect 4: The method of any of aspects 1 through 3, wherein the parameter set comprises power ramping parameters that include common values across all ROs associated with the PRACH transmissions or that include different values for at least a portion of the ROs associated with the PRACH transmissions.
Aspect 5: The method of any of aspects 1 through 4, wherein the parameter set comprises power ramping parameters that include common values across a group of cells associated with the UE, a group of one or more frequencies associated with the UE, a location area associated with the UE, or a combination thereof.
Aspect 6: The method of any of aspects 1 through 5, wherein the signal that identifies the parameter set comprises an SIB message, an RRC message, a DCI message, a paging message, a PDCCH message, a PDSCH message, a wakeup signal, a MAC-CE message, a PRACH Msg2, or a combination thereof.
Aspect 7: The method of any of aspects 1 through 6, wherein application of the parameter set is based at least in part on a UE type associated with the UE, on a feature associated with the UE, or both.
Aspect 8: The method of any of aspects 1 through 7, wherein application of the parameter set is based at least in part on an occurrence of a threshold condition associated with the UE.
Aspect 9: The method of any of aspects 1 through 8, further comprising: transmitting information that identifies one or more requested power ramping parameters, wherein the parameter set is based at least in part on the one or more requested power ramping parameters.
Aspect 10: The method of any of aspects 1 through 9, further comprising: transmitting a report that identifies one or more metrics associated with the PRACH transmissions, wherein the one or more metrics are based at least in part on the first subset of power ramping parameters, the second subset of power ramping parameters, or both.
Aspect 11: A method for wireless communications at a network entity, comprising: transmitting, to a UE, a signal that identifies a parameter set associated with power ramping operations during PRACH transmissions, wherein the parameter set comprises at least a first subset of power ramping parameters associated with a first PRACH retransmission and a second subset of power ramping parameters associated with a second PRACH retransmission, and wherein the first subset of power ramping parameters comprises one or more parameter values that are different relative to corresponding parameter values of the second subset of power ramping parameters; monitoring for the first PRACH retransmission according to the first subset of power ramping parameters; and monitoring for the second PRACH retransmission according to the second subset of power ramping parameters.
Aspect 12: The method of aspect 11, wherein the first subset of power ramping parameters, the second subset of power ramping parameters, or both, comprise a maximum transmit power level, an initial preamble transmit power level, a power ramping step size, RSRP thresholds, a maximum quantity of preamble transmissions, scaling factors, a maximum step size, a minimum step size, a step size range of values, a maximum accumulated step size value, or a combination thereof.
Aspect 13: The method of any of aspects 11 through 12, wherein the parameter set comprises power ramping parameters that include common values across all SSB beams configured for the UE or that include different values for at least a portion of the SSB beams configured for the UE.
Aspect 14: The method of any of aspects 11 through 13, wherein the parameter set comprises power ramping parameters that include common values across all ROs associated with the PRACH transmissions or that include different values for at least a portion of the ROs associated with the PRACH transmissions.
Aspect 15: The method of any of aspects 11 through 14, wherein the parameter set comprises power ramping parameters that include common values across a group of cells associated with the UE, a group of one or more frequencies associated with the UE, a location area associated with the UE, or a combination thereof.
Aspect 16: The method of any of aspects 11 through 15, wherein the signal that identifies the parameter set comprises an SIB message, an RRC message, a DCI message, a paging message, a PDCCH message, a PDSCH message, a wakeup signal, a MAC-CE message, a PRACH Msg2, or a combination thereof.
Aspect 17: The method of any of aspects 11 through 16, wherein application of the parameter set is based at least in part on a UE type associated with the UE, on a feature associated with the UE, or both.
Aspect 18: The method of any of aspects 11 through 17, wherein application of the parameter set is based at least in part on an occurrence of a threshold condition associated with the UE.
Aspect 19: The method of any of aspects 11 through 18, further comprising: receiving, from the UE, information that identifies one or more requested power ramping parameters, wherein the parameter set is based at least in part on the one or more requested power ramping parameters.
Aspect 20: The method of any of aspects 11 through 19, further comprising: receiving, from the UE, a report that identifies one or more metrics associated with the PRACH transmissions, wherein the one or more metrics are based at least in part on the first subset of power ramping parameters, the second subset of power ramping parameters, or both.
Aspect 21: A UE for wireless communications, comprising a processing system that includes processor circuitry and memory circuitry that stores code, the processing system configured to cause the UE to perform a method of any of aspects 1 through 10.
Aspect 22: A UE for wireless communications, comprising at least one means for performing a method of any of aspects 1 through 10.
Aspect 23: A non-transitory computer-readable medium storing code for wireless communications, the code comprising instructions executable by one or more processors to perform a method of any of aspects 1 through 10.
Aspect 24: A network entity for wireless communications, comprising a processing system that includes processor circuitry and memory circuitry that stores code, the processing system configured to cause the network entity to perform a method of any of aspects 11 through 20.
Aspect 25: A network entity for wireless communications, comprising at least one means for performing a method of any of aspects 11 through 20.
Aspect 26: A non-transitory computer-readable medium storing code for wireless communications, the code comprising instructions executable by one or more processors to perform a method of any of aspects 11 through 20.

It should be noted that the methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a signal that identifies a parameter set associated with power ramping operations during physical random access channel (PRACH) transmissions, wherein the parameter set comprises at least a first subset of power ramping parameters associated with a first PRACH retransmission and a second subset of power ramping parameters associated with a second PRACH retransmission, and wherein the first subset of power ramping parameters comprises one or more parameter values that are different relative to corresponding parameter values of the second subset of power ramping parameters;
perform the first PRACH retransmission according to the first subset of power ramping parameters; and
perform the second PRACH retransmission according to the second subset of power ramping parameters.

2. The UE of claim 1, wherein the first subset of power ramping parameters, the second subset of power ramping parameters, or both, comprise a maximum transmit power level, an initial preamble transmit power level, a power ramping step size, reference signal received power (RSRP) thresholds, a maximum quantity of preamble transmissions, scaling factors, a maximum step size, a minimum step size, a step size range of values, a maximum accumulated step size value, or a combination thereof.

3. The UE of claim 1, wherein the parameter set comprises power ramping parameters that include common values across all synchronization signal block (SSB) beams configured for the UE or that include different values for at least a portion of the SSB beams configured for the UE.

4. The UE of claim 1, wherein the parameter set comprises power ramping parameters that include common values across all PRACH occasions (ROs) associated with the PRACH transmissions or that include different values for at least a portion of the ROs associated with the PRACH transmissions.

5. The UE of claim 1, wherein the parameter set comprises power ramping parameters that include common values across a group of cells associated with the UE, a group of one or more frequencies associated with the UE, a location area associated with the UE, or a combination thereof.

6. The UE of claim 1, wherein the signal that identifies the parameter set comprises a system information block (SIB) message, a radio resource control (RRC) message, a downlink control information (DCI) message, a paging message, a physical downlink control channel (PDCCH) message, a physical downlink shared channel (PDSCH) message, a wakeup signal, a medium access control-control element (MAC-CE) message, a PRACH message two (Msg2), or a combination thereof.

7. The UE of claim 1, wherein application of the parameter set is based at least in part on a UE type associated with the UE, on a feature associated with the UE, or both.

8. The UE of claim 1, wherein application of the parameter set is based at least in part on an occurrence of a threshold condition associated with the UE.

9. The UE of claim 1, wherein the one or more processors are individually or collectively further operable to execute the code to cause the UE to:
transmit information that identifies one or more requested power ramping parameters, wherein the parameter set is based at least in part on the one or more requested power ramping parameters.

10. The UE of claim 1, wherein the one or more processors are individually or collectively further operable to execute the code to cause the UE to:
transmit a report that identifies one or more metrics associated with the PRACH transmissions, wherein the one or more metrics are based at least in part on the first subset of power ramping parameters, the second subset of power ramping parameters, or both.

11. A network entity, comprising:
one or more memories storing processor-executable code; and
one or more processors coupled with the one or more memories and individually or collectively operable to execute the code to cause the network entity to:
transmit, to a user equipment (UE), a signal that identifies a parameter set associated with power ramping operations during physical random access channel (PRACH) transmissions, wherein the parameter set comprises at least a first subset of power ramping parameters associated with a first PRACH retransmission and a second subset of power ramping parameters associated with a second PRACH retransmission, and wherein the first subset of power ramping parameters comprises one or more parameter values that are different relative to corresponding parameter values of the second subset of power ramping parameters;
monitor for the first PRACH retransmission according to the first subset of power ramping parameters; and
monitor for the second PRACH retransmission according to the second subset of power ramping parameters.

12. The network entity of claim 11, wherein the first subset of power ramping parameters, the second subset of power ramping parameters, or both, comprise a maximum transmit power level, an initial preamble transmit power level, a power ramping step size, reference signal received power (RSRP) thresholds, a maximum quantity of preamble transmissions, scaling factors, a maximum step size, a minimum step size, a step size range of values, a maximum accumulated step size value, or a combination thereof.

13. The network entity of claim 11, wherein the parameter set comprises power ramping parameters that include common values across all synchronization signal block (SSB) beams configured for the UE or that include different values for at least a portion of the SSB beams configured for the UE.

14. The network entity of claim 11, wherein the parameter set comprises power ramping parameters that include common values across all PRACH occasions (ROs) associated with the PRACH transmissions or that include different values for at least a portion of the ROs associated with the PRACH transmissions.

15. The network entity of claim 11, wherein the parameter set comprises power ramping parameters that include common values across a group of cells associated with the UE, a group of one or more frequencies associated with the UE, a location area associated with the UE, or a combination thereof.

16. The network entity of claim 11, wherein the signal that identifies the parameter set comprises a system information block (SIB) message, a radio resource control (RRC) message, a downlink control information (DCI) message, a paging message, a physical downlink control channel (PDCCH) message, a physical downlink shared channel (PDSCH) message, a wakeup signal, a medium access control-control element (MAC-CE) message, a PRACH message two (Msg2), or a combination thereof.

17. The network entity of claim 11, wherein application of the parameter set is based at least in part on a UE type associated with the UE, on a feature associated with the UE, or both.

18. The network entity of claim 11, wherein application of the parameter set is based at least in part on an occurrence of a threshold condition associated with the UE.

19. The network entity of claim 11, wherein the one or more processors are individually or collectively further operable to execute the code to cause the network entity to:
receive, from the UE, information that identifies one or more requested power ramping parameters, wherein the parameter set is based at least in part on the one or more requested power ramping parameters.

20. A method for wireless communications at a user equipment (UE), comprising:
receiving a signal that identifies a parameter set associated with power ramping operations during physical random access channel (PRACH) transmissions, wherein the parameter set comprises at least a first subset of power ramping parameters associated with a first PRACH retransmission and a second subset of power ramping parameters associated with a second PRACH retransmission, and wherein the first subset of power ramping parameters comprises one or more parameter values that are different relative to corresponding parameter values of the second subset of power ramping parameters;
performing the first PRACH retransmission according to the first subset of power ramping parameters; and
performing the second PRACH retransmission according to the second subset of power ramping parameters.
